(19) United States
(12) Patent Application Publication
(10) Pub. No.: US 2008/0277433 A1
(43) Pub. Date: Nov. 13, 2008

(54) MODULAR PERSONAL HYDRATION AND STORAGE SYSTEM

(75) Inventors: Frederick T. Karl, West Linn, OR (US); William M. Dierter, Portland, OR (US); John A. Nason, Keizer, OR (US); Edgar A. Dallas, Beaverton, OR (US); Nathaniel R. Halle, Minneapolis, MN (US); Brie G. Karl, West Linn, OR (US); Cynthia L. Maletz, Portland, OR (US)

Correspondence Address: FOLEY & LARDNER LLP, 777 EAST WISCONSIN AVENUE, MILWAUKEE, WI, 53202-5306, US

(73) Assignee: Fiskars Brands, Inc.

(21) Appl. No.: 12/050,759

(22) Filed: Mar. 18, 2008

Related U.S. Application Data
(60) Provisional application No. 60/918,784, filed on Mar. 19, 2007.

(51) Int. Cl. A45F 5/00; B67D 5/64

(52) U.S. Cl. 224/148.6; 222/175

(57) ABSTRACT

A personal hydration system includes a reservoir for storing a fluid and a fluid delivery system for delivering the fluid to a user. The fluid delivery system is coupled to the reservoir at a discharge port. A fill port is located on the reservoir and configured to provide an external fill access point for the reservoir. The reservoir is configured to serve as a frame for the personal hydration system.

### CROSS-REFERENCE TO RELATED PATENT APPLICATIONS

This application claims priority to and the benefit of U.S. Provisional Application No. 60/918,784, filed Mar. 19, 2007, incorporated herein by reference in its entirety.

### BACKGROUND

The present invention relates to a modular personal hydration and storage system. The present invention relates more particularly to an adaptable system having a hydration module and a variety of storage modules.

The need for a ready supply of fluids to combat dehydration during strenuous activity is well known. Commonly, people who are working or recreating take periodic refreshment breaks to hydrate themselves. However, such refreshment breaks might not occur frequently enough to properly hydrate a person performing strenuous activities.

Maintaining proper hydration levels can require the regular ingestion of fluids. Several portable devices have been developed to meet this need. Some devices include containers of rigid construction or of semi-rigid construction. These devices, such as aluminum canteens and plastic water bottles, are reasonably light, durable and inexpensive. However, they are often awkwardly mounted to a waist belt or in a pocket of a back pack, and thus typically require a user's hand for manipulating the container to access the liquid.

Portable hydration devices have been developed that include a flexible, bag-like (e.g., soft-sided) reservoir to store fluids. This type of reservoir is often configured to be worn on a user's back with a short drinking tube and mouth piece to provide hands-free access to the fluid.

### SUMMARY

According to a first embodiment of the invention a personal hydration system includes a reservoir for storing a fluid and a fluid delivery system for delivering the fluid to a user. The fluid delivery system is coupled to the reservoir at a discharge port. A fill port is located on the reservoir and configured to provide an external fill access point for the reservoir. The reservoir is configured to serve as a frame for the personal hydration system.

According to a second embodiment of the invention a modular personal hydration system includes a holder. A reservoir is provided in the holder and is configured to serve as a frame for the modular personal hydration system. A receiving structure is coupled to the holder and is configurable in various positions to provide a structure in cooperation with the holder to releasably couple with or otherwise support at least one storage module.

According to a third embodiment of the invention a modular personal hydration and storage system includes a hydration module including a holder. A reservoir is provided in the holder and is configured to serve as a frame for the modular personal hydration and storage system. A receiving structure is configurable in various positions to provide a structure to releasably couple with or otherwise support an at least one storage module. At least one storage module is removably coupled to the hydration module.

Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures, wherein like reference numerals to like elements, in which:

FIG. 1 is a rear perspective view of a modular personal hydration and storage system, according to one embodiment, with a hydration module having a receiving structure/panel in one position.

FIG. 2 is a rear perspective view of the system according to the embodiment of FIG. 1, with a hydration module having a receiving structure/panel in another position.

FIG. 3 is a rear perspective view of the system according to the embodiment of FIG. 2, with a first (small) storage module coupled to the hydration module.

FIG. 4 is a rear perspective view of the system according to the embodiment of FIG. 1, with a second (large) storage module coupled to the hydration module.

FIG. 5 is a rear perspective view of the system according to the embodiment of FIG. 4, with a first (small) storage module and a second (large) storage module coupled to the hydration module.

FIG. 6 is a front perspective view of the system according to the embodiment of FIG. 5, with a first (small) storage module and a second (large) storage module coupled to the hydration module.

FIG. 7 is a rear perspective view from an opposite side of the system according to the embodiment of FIG. 1, with an externally accessible fill port for the hydration module.

FIG. 8 is a side view of the system according to an alternative embodiment of FIG. 4, with the first (small) module coupled to the hydration module.

FIG. 9 is a partial rear perspective cutaway view of the hydration module showing a reservoir according to the embodiment of FIG. 1.

FIG. 10 is a front perspective view of the reservoir for the hydration module according to the embodiment of FIG. 9.

FIG. 11 is an exploded front perspective view of the system according to the embodiment of FIG. 1, with a padded waist belt removably attachable to the hydration module.

FIG. 12 is a detailed view of a vented fill cap attachable to the reservoir of the hydration module, according to the embodiment of FIG. 10.

FIG. 13 is a rear perspective view from one side of the reservoir for the hydration module according to the embodiment of FIG. 10.

FIG. 14 is a rear perspective view from another side of the reservoir for the hydration module according to the embodiment of FIG. 13.

### DETAILED DESCRIPTION

Before turning to the figures which illustrate the exemplary embodiments in detail, it should be understood that the application is not limited to the details or methodology set forth in the following description or illustrated in the figures. It should also be understood that the terminology employed herein is for the purpose of description only and should not be regarded as limiting.

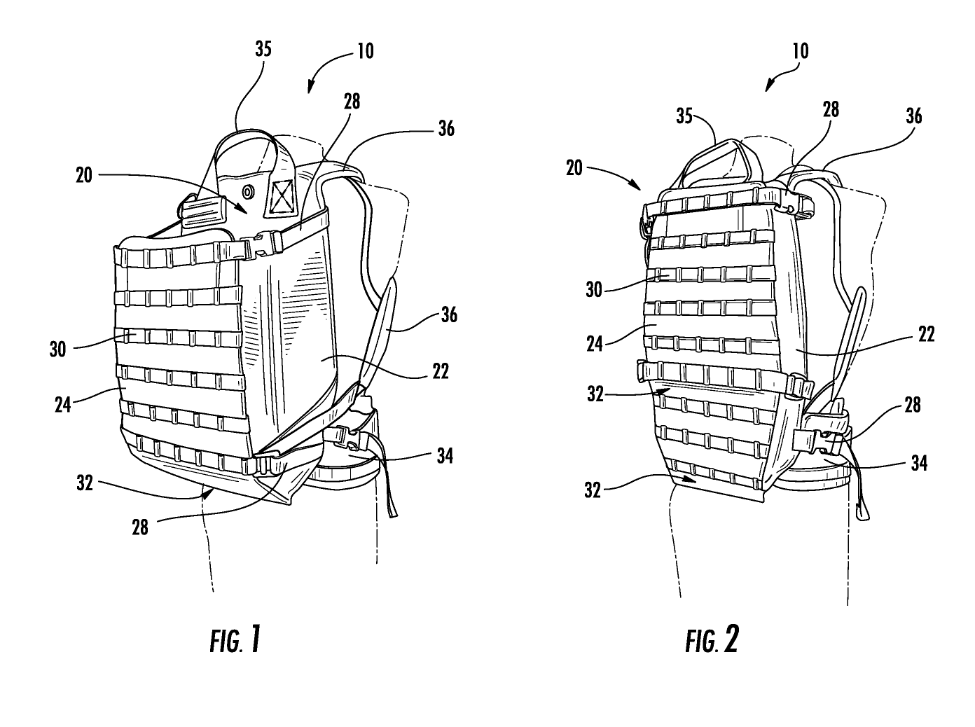

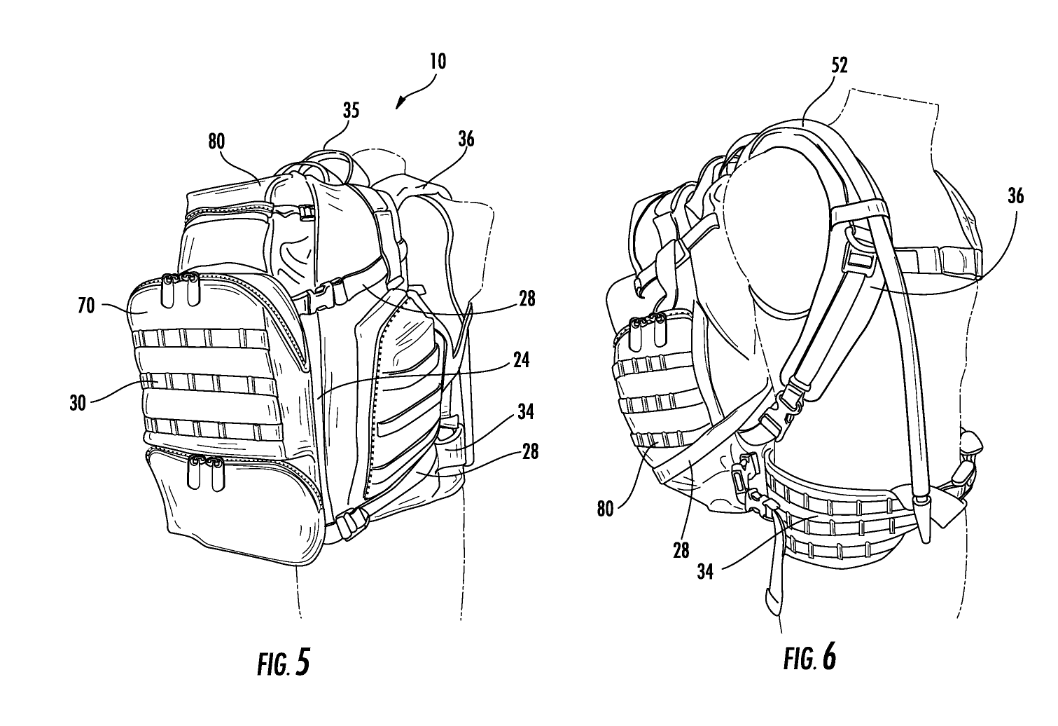

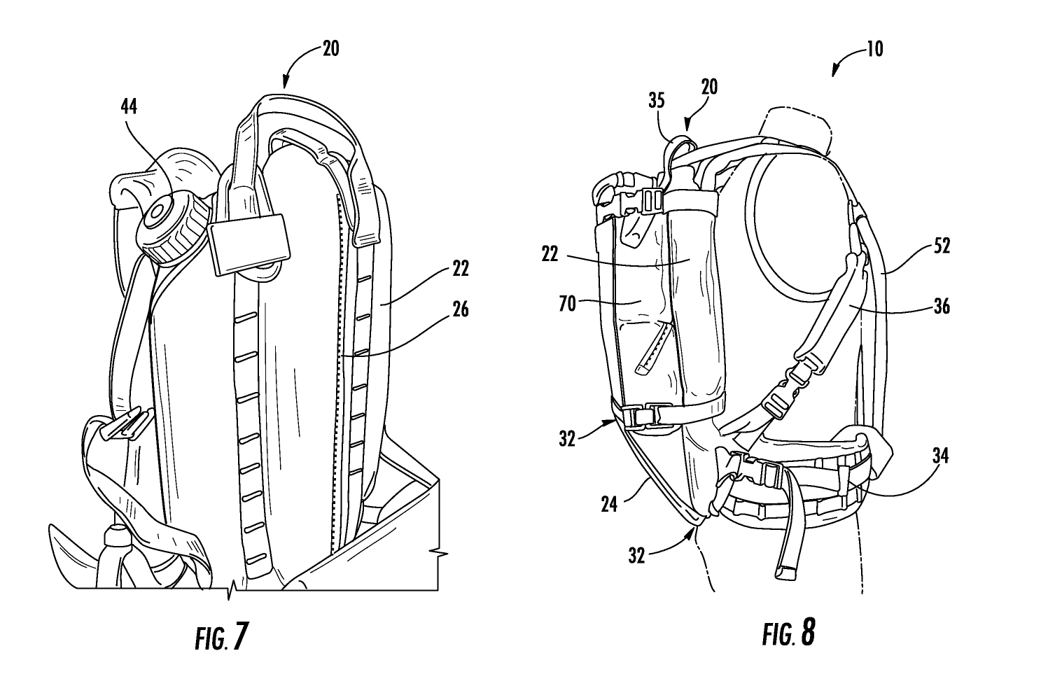

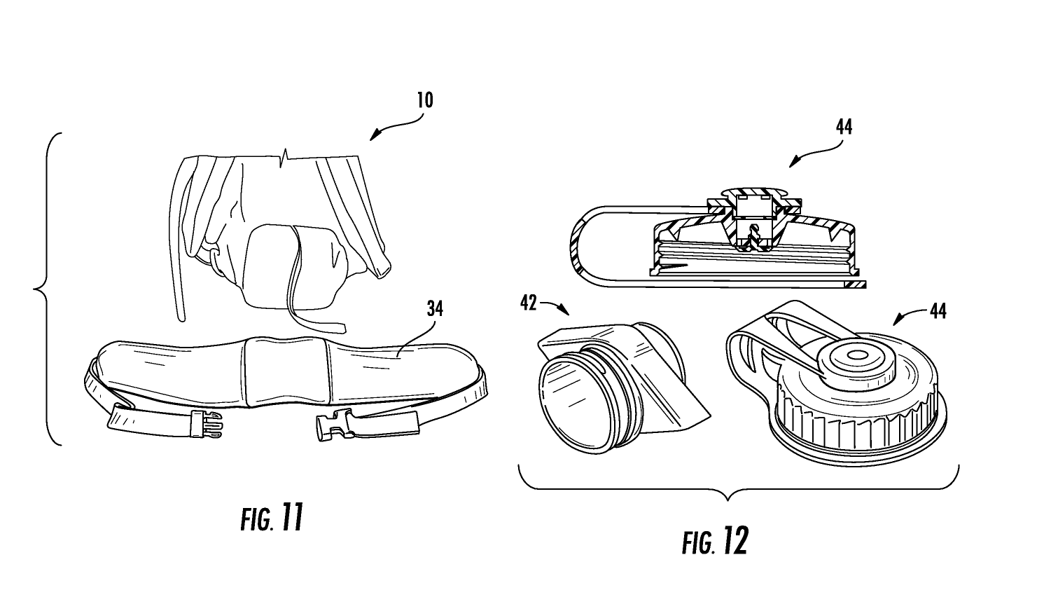

Referring to FIGS. 1-14, a modular personal hydration and storage system 10 in the form of a backpack is shown according to one embodiment to include a hydration module 20, a hydration fluid reservoir 40, and a fluid delivery system 50 to provide fluids from the reservoir to a user. The modular personal hydration and storage system 10 may also include a first storage module 70 (shown for example as a “small” storage module), and/or a second storage module 80 (shown for example as a “large” storage module).

The hydration module 20 functions as the “base” of the system 10 and serves multiple purposes. First, the hydration module 20 includes the reservoir 40 to serve as a hydration fluid storage device. Second, the reservoir 40 of the hydration module 20 serves as a structural frame for the backpack (e.g., in the manner of a “fluid-frame” etc.). Third, the hydration module 20 serves as a free-form base (e.g., carrier, platform, etc.) for receiving various storage modules (or combinations of storage modules) to create a modular customizable backpack system. The hydration module 20 as shown does not interfere with the cargo storage capacity of the storage modules 70, 80.

The system 10 is shown by way of example as generally intended for use in military applications, but may be used by any person in any type of activity such as outdoor recreation, vocational, etc. The user may be any person engaged in any activity in which hydration of the user's body is desirable, such as extended periods away from conventional hydration sources, recreation, work or other strenuous activity or where the user is exposed to environments or conditions that tend to dehydrate the user. The system 10 is shown, for example, to include two storage modules (a “small” module and a “large” module); however, any additional number of storage modules of any relative size may be included for customizing the backpack for a desired application. Alternatively, the hydration module base may be used alone (e.g., without any storage modules) to provide hydration capability, along with the ability to receive future cargo/gear (via the connectors on the hydration module or on the load panel, etc.) in the event such need arises.

According to other embodiments, or variations or modifications of the illustrated embodiments, the modular personal hydration and storage system may include any desirable number of cargo/gear modules, that may be selectively combined in any desirable arrangement on a hydration module base, where the reservoir also serves as a frame. The system 10 provides a backpack having hydration capability and cargo storage and transport capability suited to any particular use or application desired by a user, by combining (e.g., coupling) the desired module(s) to the hydration module platform or base.

According to other embodiments, the system may be used as a hydration system alone without storage modules (such as a hydration module alone or as a hydration module alone yet with the capability to receive additional cargo). According to further embodiments, the reservoir may be used alone or by itself (such as a water jug or inside a soldier's body armor). According to further embodiments, the hydration module and storage modules may be integrated into a single pack that combines a compartment for the reservoir (to provide a frame for the pack and to provide hydration capability) and a cargo storage volume. According to other embodiments, the hydration module, reservoir, and backpack may be provided in any desirable size. All such embodiments, and variations or modifications, are intended to be included within the scope of this disclosure.

For purposes of this disclosure, the term “coupled” is intended to mean the joining of two members or objects directly or indirectly to one another. Such joining may be stationary in nature or movable in nature. Such joining may be achieved with the two objects alone, or the two objects and any additional intermediate members or objects (e.g., connectors, clips, brackets, straps, snaps, modules, webbing, etc.), either integrally formed or separately formed. Such joining may be permanent in nature or alternatively may be removable or releasable in nature.

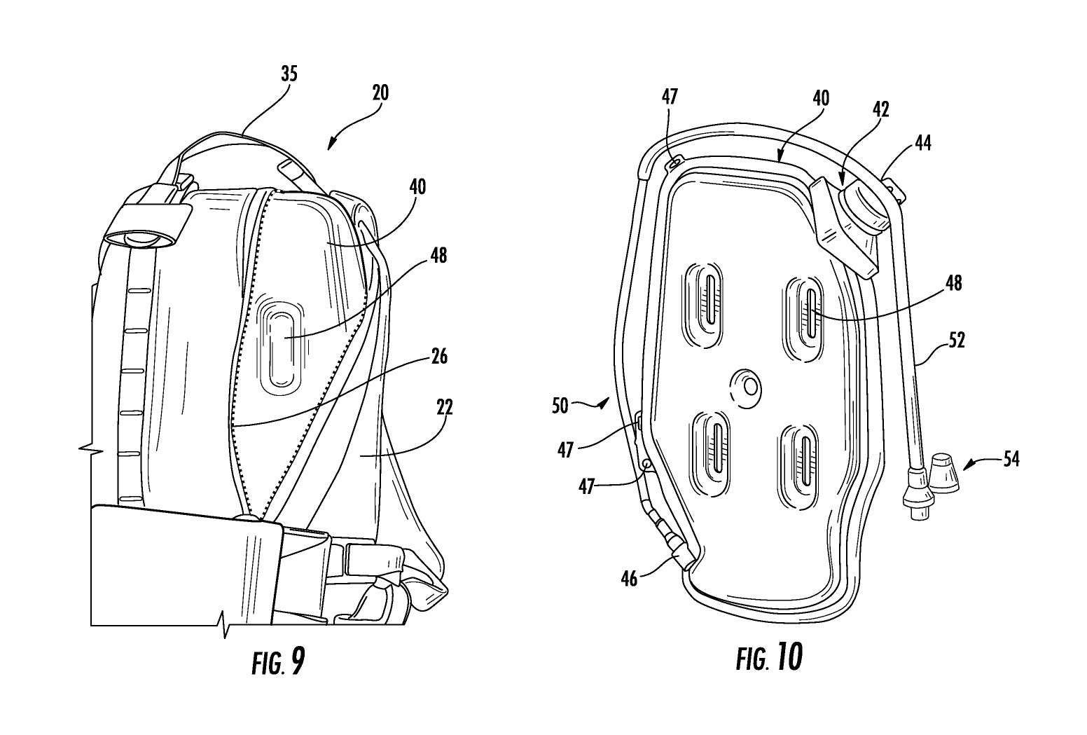

Referring to FIGS. 1 and 2, the system 10 in the form of a backpack is shown to include a hydration module 20. Hydration module 20 is intended to provide a free-form “base” for the backpack and to receive and support the other modules of the system. The hydration module 20 is shown to include a holder 22 (e.g., receptacle, pocket, sleeve, etc.) for receiving and securing a hydration fluid reservoir 40 (see FIG. 9), and a receiving structure (shown as a load flap or panel 24) for customizing the backpack to provide desired cargo/gear storage and transport capability.

The holder 22 of the hydration module 20 is shown as a generally planar compartment (e.g., sleeve, pocket, elongated compartment, etc.) made from a flexible material that removably receives reservoir 40 in a generally snug-fitting arrangement and may be secured by a suitable closure (shown for example as a zipper 26 in FIG. 9). The holder 22 with the reservoir 40 installed (to provide structural support) is sized and shaped to serve as a “base” or “platform” for the backpack, and is capable of receiving any of a wide variety of other modules. When the reservoir 40 is provided or installed in the holder 22, the shape and stiffness of the reservoir 40 (held snugly within the space in the holder) provides sufficient firmness (e.g., structure and rigidity)—with or without fluid in the reservoir—to permit the reservoir 40 and holder 22 to serve as a frame (e.g., structural support panel, etc.) for the backpack. The holder 22 and reservoir 40 are also provided with a “slim” or narrow width/thickness (e.g., “flattened”) so that the weight of the fluid is held close to the user's back to minimize rearward tipping, leverage, and strain on the user. The distribution of the weight of the fluid across the width and height of the base or platform is also intended to help stabilize the backpack when additional objects are carried by (or supported on) the hydration module 20. In addition to providing structural integrity for the backpack, placement of the reservoir 40 within the holder 22 of the hydration module 20 is also intended to provide a system in which the reservoir does not interfere with the cargo carrying capacity of the backpack, and permits refilling of the reservoir 40 from an external top/side fill port 42 that remains continuously accessible in any of a wide variety of storage module configurations on the backpack. Having the external fill port 42 allows the reservoir 40 to be easily and efficiently filled without the removal of the reservoir 40 from the system 10.

According to other embodiments, the reservoir may take different shapes and/or sizes and may be placed in other packs besides a backpack. For instance, the reservoir may be shaped and/or sized to be placed in a pack to be worn around the waist of a user (e.g., a fanny pack, a holster-type pack, etc.). Additionally, the reservoir may be shaped and/or sized to be placed in a pack to be worn near the chest or ribcage of a user (e.g., inside a soldier's body armor or inside a vest). In each of these embodiments, the reservoir would still have an external (e.g., top, side) fill port that remains accessible in any of a wide variety of configurations. Having the external fill port allows the reservoir to be easily and efficiently filled without the removal of the reservoir from the pack.

The receiving structure (e.g., load panel, flex-panel, back-flap, “beaver tail,” etc.) is shown as a panel 24 having a bottom end coupled to a bottom of the holder 22, and having a top end releasably attachable to a top of the holder 22, and an intermediate portion of the panel 24 is shown releasably attachable to an intermediate portion of the holder 22. The releasable attachment of the sections of the panel 24 to the holder 22 may be accomplished by any suitable connecting structure 28, such as straps, buckles, clips (e.g., MALICE type clips), hook and loop fasteners (e.g., Velcro, etc.), snaps, buttons, zippers, elastic cords, etc. The panel 24 may also be provided with attachment features for securing other modules or articles. For example, the panel 24 may include webbing 30 (e.g., MOLLE type webbing) for interconnection with webbing on other modules or articles.

The panel may be provided as a lightweight, durable fabric or material with a reinforcement (such as an insert) made from a lightweight semi-rigid material (e.g., plastic, etc.) to provide strength and durability, yet has sufficient flexibility to be movable or conformable to a variety of positions for receiving other modules of the system. The panel 24 is also shown to include one or more hinges 32 (e.g., a living hinge, fabric hinge, etc.—such as separations between reinforcement insert panels) to provide a joint for folding or hinging the panel into various positions. For example, referring to FIG. 1, the panel 24 is shown to extend rearward and upward to create a “sling” that may be used to carry a wide variety of objects, such as storage modules (to be further described herein) and/or any of a wide variety of bulky, elongated or odd shaped objects or gear (e.g., logs, equipment, weapons, shovels, etc.—not shown) that may not fit within a storage module. Panel 24 may then be tightened or cinched about such objects using the connecting structure 28. Alternatively, referring to FIG. 2, the panel 24 may be “collapsed” (e.g., folded flat or substantially flat) against the holder 22 to provide a “slim-line” backpack (or when the system is intended to serve primarily as a hydration unit, such as when other cargo storage or transport capability is minimal, or not desired or required).

Referring further to FIGS. 1, 2 and 6, the hydration module 20 is also shown to include a removably attachable padded waist belt 34 that may be installed or removed (using suitable connectors as previously described) to provide additional support for the pack when desired by a user. As another modular component of the system 10, the belt 34 may be added to provide support when the backpack will be used in a task involving heavy or bulky cargo transport. Alternatively, the belt 34 may be omitted when the backpack will be used in light-duty applications.

The hydration module 20 is further shown to include additional features intended to enhance the functionality of the backpack, such as a handle 35, padding (e.g., foam, etc., not shown—but may be provided along a front of the hydration module 20 to cushion the module on a user's back torso), adjustable and removable padded shoulder straps 36, accessory (e.g., radio, telephone, etc.) clips and straps, compartments and pockets, compression or elastic cording to cinch-down and secure loads, etc.

According to one embodiment, the holder and storage modules are made from lightweight durable materials such as Nylon, Nylon mesh, other suitable fabrics (e.g., natural or synthetic), etc. and may include padding or cushioning at suitable locations to enhance comfort to the user. The modules are formed using creative patterning to decrease the number of seams (and thus weight and material) of the system 10. Utilizing patterning that reduces the number of seams also reduces the vulnerability of the system 10 to failure (e.g., a seam ripping or tearing) and to areas where water or moisture may enter the system 10. The webbing used for the MOLLE grid may be less than an inch wide (e.g., ¾ of an inch wide, ½ of an inch wide, etc.) to reduce weight. Also, segments of plastic sheeting may be included in the modules (e.g. provided on the inside of the module, sewn-in, etc.) to help hold the shape and rigidity of the modules when empty or to improve usability of the MOLLE grid webbing when the pockets behind the webbing are empty.

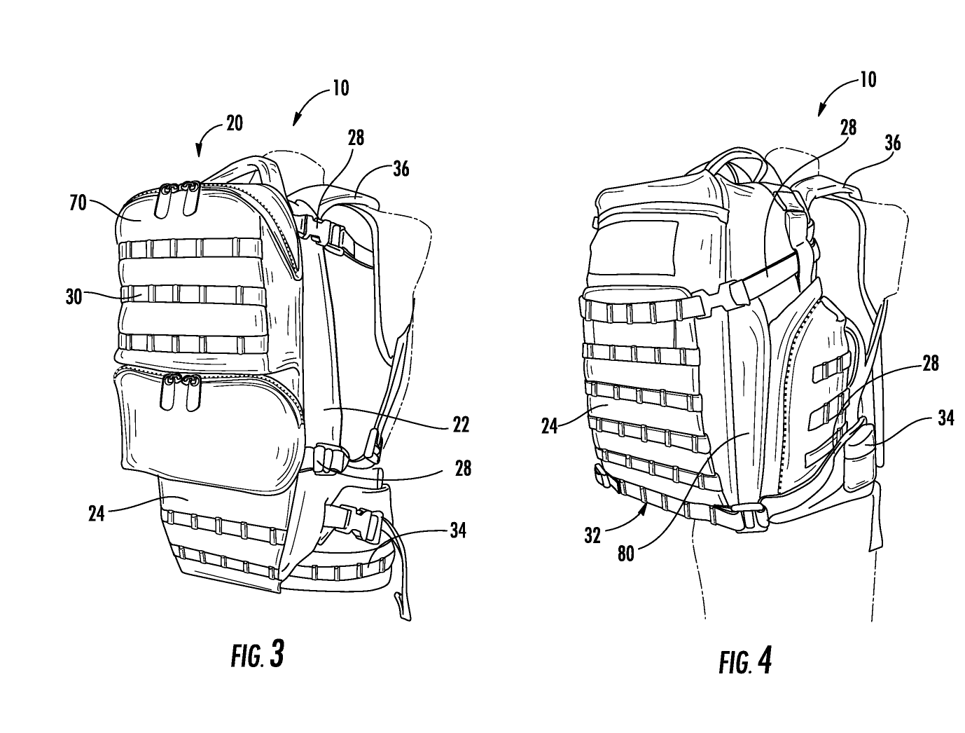

Referring to FIGS. 3-8, for applications in which the use of storage modules is desirable, the system 10 is shown to include storage modules that are removably and interchangeably coupled to the “base” hydration module 20 (i.e. the holder 22 and/or panel 24). According to an exemplary embodiment, one type of storage module is provided as a “small” storage module 70 (for holding “small” articles, or a small quantity of articles) which may be coupled to the base in any of a number of ways. For example, as shown in FIG. 3, small storage module 70 may be coupled to a rear surface of panel 24 using suitable connectors (such as a MALICE type clip—as previously described), with panel 24 in a collapsed position. According to another example, as shown in FIG. 8, small storage module 70 may be coupled between panel 24 and holder 22, with the panel 24 in a partially extended position.

According to an exemplary embodiment, another storage module is provided as a “large” storage module 80 (for holding “large” articles, or a large quantity of articles) which may also be coupled to the base in any number of ways, and with or without the small module 70 (or any other modules that may be used with the system). For example, as shown in FIG. 4, large module 80 may be coupled between panel 24 and holder 22, with the panel 24 in a fully extended position. According to another example, as shown in FIG. 5, large module 80 may be coupled between panel 24 and holder 22, with the panel 24 in a fully extended position, and small module 70 may be coupled to a rear (exterior) surface of the panel 24. Coupling of the large module to the base may be accomplished using any suitable connectors, such as MALICE clips, straps, buckles, etc., as previously described. Alternatively, the large module may be provided with a sleeve that hugs or surrounds the hydration module 20.

The small and/or large modules may be provided with additional functionality to suit intended applications. For example, the modules may include radio antenna and/or communication cable ports on either side, and may also include slings, pockets, nets, etc. of various sizes. For example, a module may include an internal sling or pocket to support objects such as electronic equipment (e.g., communications devices, military radio devices, computation devices, etc.), and a smaller sling or pocket may be provided to support smaller objects (e.g., global positioning system devices, mobile phones, etc.).

According to an exemplary embodiment, one or more of each of the small and large modules 70, 80 may be coupled to the base hydration module 20 in any desired combination or configuration to create a customized backpack suited for use with a particular task. In addition, other modules of any desired size or shape may be provided to optimize the functionality of the modular hydration and storage system.

Referring to FIGS. 9-14, the reservoir 40 and fluid delivery system 50 of the modular personal hydration and storage system are shown according to one embodiment. Reservoir 40 is shown as a substantially “flat” (e.g., generally planar), semi-rigid reservoir (e.g., tank, bladder, sleeve, flask, etc.) for storing a fluid. The fluid may be drawn from the reservoir 40 through the fluid delivery system 50 for on-demand hydration of the user. According to an alternative embodiment, the reservoir may have a contoured shape intended to generally follow the contour of a user's back (e.g., form-fit, etc.).

The reservoir 40 includes a fill port 42 shown located at an upper corner (e.g., top/side) to provide an external fill access point that remains available during substantially all storage module attachment configurations. Location of the fill port 42 in a “gas can” style placement is intended to permit quick and accurate refilling (e.g., by someone other than the user, while the backpack is worn by the user, etc.), without removal of any cargo or gear from the backpack. Fill port 42 is shown having an enlarged mouth size intended to receive/fit filtration media as the reservoir 40 is refilled. The fill port 42 is enclosed by a threaded fill cap 44 having a tether to prevent loss of the cap, and a (leak-free) vacuum relief valve or diaphragm (see FIG. 12) to permit air flow into the reservoir 40 as fluid is drawn through the delivery system 50 (or in response to elevation or temperature changes) to minimize the effort needed by a user to draw fluid from the reservoir 40.

Referring to FIG. 10, reservoir 40 is also shown to include a discharge port 46 for coupling to the fluid delivery system 50. Discharge port 46 is shown located near a bottom portion of the reservoir 40 to maximize the capacity of fluid that may be drawn by the user. Fluid delivery system 50 is shown to include a conduit 52 (e.g., tube, hose, etc.) having a first end releasably connectible to the discharge port 46 (by a suitable connector, such as a quick-disconnect fitting, etc.). A second end of conduit 52 includes a device 54 (e.g., a hands-free valve, such as a bite-valve, a user-actuated valve, a lockout valve, etc.) to permit a user to draw fluid on demand, and a lock-out device (shown for example as a pop-up type sealing device (e.g., push-pull, etc.), but may also be a clamp, twist-lock valve, stopper, etc.) to prevent inadvertent fluid discharge during periods when hydration is not desired.

Referring further to FIG. 10, the reservoir 40 is also shown to include features shown as hang points 47 to permit the reservoir 40 to be suspended (e.g., from a hook, bracket, or the like) to permit the reservoir 40 to drain and to dry. In one embodiment, a semi-rigid nature of the reservoir 40 permits the reservoir to retain its general shape when empty to enhance air circulation through the reservoir interior space and reduce drying time.

According to an exemplary embodiment, reservoir 40 is formed as a semi-rigid, three-dimensional body. Reservoir 40 may be made from two halves of plastic material that may be laminated and then vacuum formed into the desired shape. The two halves may be coupled (e.g., welded, glued, fastened) together along a peripheral seam to create a semi-rigid reservoir body. The semi-rigid nature of the reservoir 40 allows the reservoir 40 to be deformable when a force (e.g., external force, internal force) is applied, but returns back to its original shape when the force is removed. The semi-rigid nature of the reservoir 40 also allows the fill port 42 to be self supported (i.e. the fill port 42 of reservoir 40 retains its shape and can stand by itself) allowing fill port 42 to be accessed with ease (reservoir 40 is easily filled). The plastic materials provide sufficient durability to resist general abuse of the reservoir (e.g., dropping it, loading objects on it, punctures, etc.). The interior surface of the halves may be coated with an antimicrobial agent.

As shown in FIGS. 10 and 13-14, the halves may be formed with an internal connecting structure (e.g., baffles, etc.—shown for example as four baffles 48 having an elongated shape, but may be any number of baffles having any desired shape) to increase the rigidity and strength of the reservoir 40, and to reduce or minimize sloshing or undesirable movement of fluid within the reservoir 40.

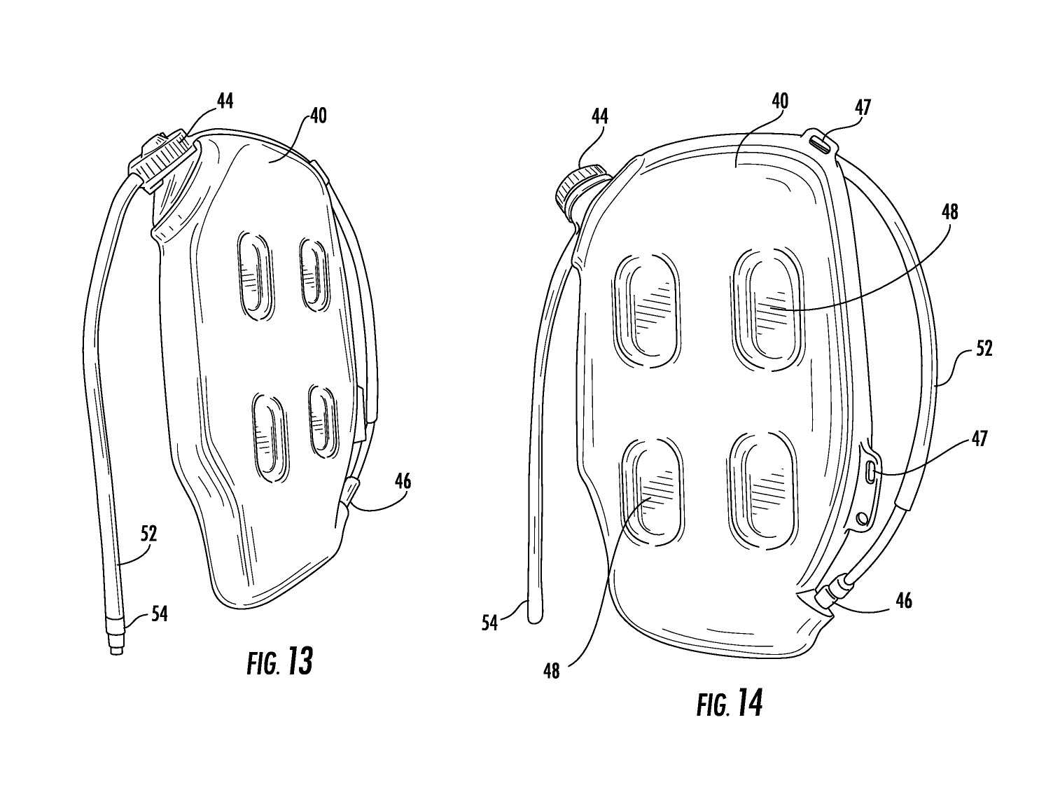

The baffles 48 may be formed as indentations on each body half that may be welded together (see FIGS. 13-14). Alternatively, the baffles may be provided as through-apertures (see FIG. 10), where the apertures may also serve as receptacles for mounting the reservoir 40 on brackets or other connectors (e.g., on body armor, in transport vehicles, etc.). The apertures in baffles 48 are also intended to serve as connection passages (e.g., lashing points, etc.) so that the reservoir 40 may be attached to other objects. For example, multiple reservoirs (e.g., in an empty condition) may be stacked or bundled and lashed together through the passages for storage or transport, and may (for example) be mounted to a hydration module 20 base as cargo for transport on the backpack of the system. By further way of example, the reservoirs may be attached through the passages to other objects, such as user-wearable body armor or ballistic armor, or to mounting brackets for storage and/or transport in military (or other type) vehicles (using suitable connection methods or devices, such as MOLLE grid webbing, D-rings, ropes, MALICE type clips).

According to an exemplary embodiment, the two halves of the reservoir body may be formed as generally symmetric members, or may be non-symmetric. For example, one half of the body may be formed in a shape intended to fit the contour of a user's back, while the other half may be formed in a shape configured to receive and support cargo or modules for storing cargo.

According to an alternative embodiment, the holder portion of the hydration module may be omitted and the reservoir may be provided (e.g., molded, etc.) with structure for receiving shoulder straps and a waistbelt, and a receiving panel. The receiving panel may be integrally molded with the reservoir body and extend therefrom (e.g., in the manner of a flap or tail), or may be hingably coupled to the reservoir body.

According to an alternative embodiment, the reservoir may be made from any suitable material and using any suitable process for providing a fluid storage device suitable for use as a hydration module of a modular backpack system. According to another alternative embodiment, the reservoir may be provided in various sizes (e.g., for storage of various quantities of fluid). For example, the reservoir body may have the same general height and width for fitting within the holder and serving as a frame, but may have different thicknesses for increasing the modularity of the system to permit adaptation to various hydration fluid transport requirements.

One embodiment of the invention relates to a modular personal hydration and storage system in the form of a backpack having a hydration module and various storage modules. The hydration module includes shoulder straps and a removable waist belt, and serves as a free-form base or carrier for coupling and supporting the storage modules so that the backpack can be customized to suit the needs of a user. The hydration module also includes a hydration fluid reservoir. The reservoir serves as a frame for the backpack and distributes the weight of the fluid across the back of a user and helps to stabilize other loads (such as the storage module(s)) supported by the hydration module. A fluid delivery system is coupled to the reservoir to provide a supply of the fluid to the user. The hydration module also includes a hinged, semi-flexible load panel that is configurable in various positions to provide a structure (in cooperation with the hydration module) to releasably couple with (or otherwise support) one or more storage modules.

According to various exemplary embodiments, the present invention provides a modular personal hydration and storage system 10 having a variety of advantageous features for use in a wide variety of applications where hydration of a user is desirable in combination with storage or transport of cargo or other objects, in many applications such as vocational, recreational, military, etc.

The system 10 includes a hydration module 20 that functions as the “base” of the system 10 that provides hydration capability to the user, and that serves as a structural frame for the backpack. In the event that additional storage capacity is desired, the hydration module 20 also functions as a platform for receiving the various storage modules, that together with the hydration module 20, make up the backpack.

The hydration module 20 includes a lightweight, relatively rigid, and durable reservoir 40 having an externally-accessible tethered fill cap 44 including a vent valve near a top/side corner and an integrally formed fluid withdrawal port near a bottom end for routing fluid from the reservoir 40 through a fluid delivery system 50 for consumption by a user. The orientation and the shape of the reservoir 40 are intended to define a fluid storage component that is readily and easily cleaned and dried, and that also functions as a “frame element” when used in connection with the holder of the hydration module 20 to provide a free-form module-receiving “base” for a backpack or the like.

A fluid delivery system 50 is also included providing a fluid delivery conduit 52 and a device 54 intended to provide control for minimizing unintended dispensing of fluid. The device 54 may include a flow control member (e.g., having structure that provides tactile indication to a user to permit one-handed, “no-look” operation).

The hydration device also includes a durable semi-flexible and hinged load panel 24 configured to permit coupling of various combinations of storage modules to the base hydration module 20 for customizing a backpack suited for a desired task or application. The storage modules may be provided in any of a wide variety of shapes and sizes, and configured for coupling to the hydration module “base” (and/or to each other) using suitable connection devices (as previously described).

According to an alternative embodiment, the system may include a backpack that integrates the reservoir with a storage module in a single device, so that the reservoir provides structural support as the frame of the backpack and provides fluid transport capability. For example, the backpack may include various compartments, such as a reservoir “holder” compartment extending along/across a user's back to receive the reservoir and function as the frame, and one or more storage compartments (e.g., fixed, sliding, etc.) that combine to provide the backpack system.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any process or method steps may be varied or re-sequenced according to alternative embodiments.

It is important to note that the construction and arrangement of the elements of the modular personal hydration and storage system provided herein are illustrative only. Although only a few exemplary embodiments of the present invention have been described in detail in this disclosure, many modifications are possible (such as variations in features such as components, materials, thicknesses, capacities, shapes, dimensions, proportions and configurations of the hydration module, storage modules, reservoir, fluid delivery system, etc.) without materially departing from the novel teachings and advantages of the invention. For example, the reservoir may be provided in any desirable rigidity, shape or contour to achieve optimum performance of the reservoir to operate as a frame for the backpack and to distribute and stabilize the weight of the system. In addition, any of a wide variety of connection devices (or combinations of connection devices) may be used for coupling the elements of the system to one another (or for attaching objects to the system). Further, it is readily apparent that variations of the system and its components and elements may be provided in a wide variety of types, shapes, sizes and performance characteristics. Accordingly, all such modifications are intended to be within the scope of the invention.

Other substitutions, modifications, changes and omissions may be made in the design, operating configuration and arrangement of the preferred and other exemplary embodiments without departing from the spirit of the invention as expressed in the appended claims.

What is claimed is:

1. A personal hydration system comprising:
a reservoir for storing a fluid;
a fluid delivery system for delivering the fluid to a user, the fluid delivery system coupled to the reservoir at a discharge port;
a fill port located on the reservoir and configured to provide an external fill access point for the reservoir;
wherein the reservoir is configured to serve as a frame for the personal hydration system.

2. The personal hydration system of claim 1, wherein the reservoir further comprises features to permit the reservoir to be suspended to permit the reservoir to drain and to dry.

3. The personal hydration system of claim 1, wherein the reservoir further comprises at least one baffle provided in the reservoir to control movement of the fluid.

4. The personal hydration system of claim 3, wherein the at least one baffle is provided between a first side of the reservoir and a second side of the reservoir.

5. The personal hydration system of claim 1, wherein reservoir is formed from two halves of plastic material that are welded together at a seam.

6. The personal hydration system of claim 5, wherein the two halves of plastic material are vacuum formed into the desired shape of the reservoir.

7. A modular personal hydration system comprising:
a holder;
a reservoir provided in the holder and configured to serve as a frame for the modular personal hydration system; and
a receiving structure coupled to the holder and configurable in various positions to provide a structure in cooperation with the holder to releasably couple with or otherwise support at least one storage module.

8. The modular personal hydration system of claim 7, further comprising at least one shoulder strap and a waist belt removably coupled to the modular personal hydration system.

9. The modular personal hydration system of claim 7, wherein the reservoir further comprises an external fill port.

10. The modular personal hydration system of claim 9, wherein the external fill port remains available when at least one storage module is removably coupled to the modular personal hydration system.

11. The modular personal hydration system of claim 7, wherein the receiving structure is hingedly coupled to the holder at a first end and releasably attached to the holder by a connecting structure at a second end.

12. The modular personal hydration system of claim 11, wherein the receiving structure has at least one hinge to provide a joint for hinging the receiving structure into various positions.

13. The modular personal hydration system of claim 12, wherein the receiving structure is configured to receive at least one storage item between an interior side of the receiving structure and the holder, wherein the receiving structure is cinched about the at least one storage item by the connecting structure.

14. The modular personal hydration system of claim 7, wherein the reservoir does not interfere with the cargo capacity of the modular personal hydration system.

15. A modular personal hydration and storage system comprising:
a hydration module comprising;
a holder;
a reservoir provided in the holder and configured to serve as a frame for the modular personal hydration and storage system and to distribute the weight of a fluid in the reservoir across the back of a user;
a receiving structure that is configurable in at least two positions to provide a structure to releasably couple with or otherwise support at least one storage module; and
at least one storage module removably coupled to the hydration module.

16. The modular personal hydration system of claim 15, wherein the reservoir further comprises a fill port that remains available when the at least one storage module is removably coupled to the hydration module.

17. The modular personal hydration and storage system of claim 15, wherein the at least one storage module is removably coupled to an exterior side of the receiving structure.

18. The modular personal hydration and storage system of claim 15, wherein the at least one storage module is removably coupled between the holder and an interior side of the receiving structure.

19. The modular personal hydration and storage system of claim 18, wherein a second storage module is removably coupled to an exterior side of the receiving structure.

20. The modular personal hydration and storage system of claim 15, wherein the receiving structure is hingedly coupled to the holder at a first end and releasably attached to the holder by a connecting structure at a second end.

21. The modular personal hydration and storage system of claim 15, wherein the reservoir does not interfere with the cargo capacity of the modular personal hydration and storage system.

22. The modular personal hydration and storage system of claim 15, wherein the modular personal hydration and storage system has the ability to adjust a size and/or volume of the modular personal hydration and storage system to a specific task by removing or adding modules thereby eliminating the need to have multiple modular personal hydration and storage systems.
